(19) United States
(12) Patent Application Publication
(10) Pub. No.: US 2013/0242421 A1
(43) Pub. Date: Sep. 19, 2013

(54) POSITION DETECTION DEVICE, IMAGE PICKUP APPARATUS, AND MAGNET

(71) Applicant: SONY CORPORATION, Tokyo (JP)

(72) Inventor: Tomoya Takei, Tokyo (JP)

(73) Assignee: SONY CORPORATION, Tokyo (JP)

(21) Appl. No.: 13/785,013

(22) Filed: Mar. 5, 2013

(30) Foreign Application Priority Data
Mar. 15, 2012 (JP) 2012-058214

(51) Int. Cl. G01D 5/16; G02B 7/04

(52) U.S. Cl. CPC G01D 5/16; G02B 7/04
USPC 359/824; 324/207.21

(57) ABSTRACT

There are provided a position detection device that makes it possible to enhance the precision of detection, an image pickup apparatus equipped with the position detection device, and a magnet provided in the position detection device. The position detection device includes: a magnet and a magnetic detection device arranged opposite to each other to be relatively movable in a straight-line direction. The magnet has a first surface facing the magnetic detection device, and has periodic projections and recesses arrayed on the first surface in a relative movement direction.

### CROSS-REFERENCE TO RELATED APPLICATION

The present application claims priority from Japanese Patent Application No. JP 2012-058214 filed in the Japanese Patent Office on Mar. 15, 2012, the entire content of which is incorporated herein by reference.

### BACKGROUND

The present disclosure relates to a position detection device suitable for detecting a position of a lens in an optical axis direction, an image pickup apparatus equipped with the position detection device, and a magnet provided in the position detection device.

In general, lens drivers included in, for example, video cameras or digital still cameras having an autofocus function or a motorized zoom function are provided with a position detection device that detects a position of a moving focus lens or a moving zoom lens. For a position detection device of this type, in relatively many cases, a magneto resistive (MR) device such as an MR sensor is used, which converts the change in magnetic force of a magnet into an electrical signal.

Such a position detection device includes a magnet for positional detection and a magneto-resistive effect device, for example, as described in Japanese Unexamined Patent Application Publication No. 2002-169073. Specifically, the magnet for positional detection is magnetized to have the magnetic poles alternating along a travel direction of a moving part. The magneto-resistive effect device is configured to vary its resistance, according to the change in magnetism, and is secured to a fixed member so as to face an area over which the magnet for positional detection moves.

### SUMMARY

Unfortunately, since magnets for positional detection, as described above, are magnetized to have the magnetic poles alternating along a travel direction of a moving part, there are cases where the magnetized widths of each N pole and each S pole vary from each other. These variations may become a factor of deteriorating the precision of detection.

There is a need for a position detection device that makes it possible to enhance the precision of detection, an image pickup apparatus equipped with the position detection device, and a magnet provided in the position detection device.

According to an embodiment of the present disclosure, there is provided a position detection device including a magnet and a magnetic detection device arranged opposite to each other to be relatively movable in a straight-line direction. The magnet has a first surface facing the magnetic detection device, and has periodic projections and recesses arrayed on the first surface in a relative movement direction.

In the position detection device according to the embodiment of the present disclosure, one of the magnet and the magnetic detection device moves relative to the other in the straight-line direction, together with a target for positional detection. This enables the magnetic detection device to detect a magnetic field on the first surface of the magnet which faces the magnetic detection device.

Since the periodic projections and recesses arrayed in the relative movement direction are provided on the first surface of the magnet which faces the magnetic detection device, the lowering of the detection precision due to the variation in the magnetized width is suppressed, as opposed to techniques in related art. Therefore, the detection precision is enhanced.

According to an embodiment of the present disclosure, there is provided an image pickup apparatus including: a lens configured to be movable in an optical axis direction; and a position detection device for the lens, and the position detection device includes a magnet and a magnetic detection device arranged opposite to each other to be relatively movable in a straight-line direction. The magnet has a first surface facing the magnetic detection device, and has periodic projections and recesses arrayed on the first surface in a relative movement direction.

In the image pickup apparatus according to the embodiment of the present disclosure, when the lens moves in the optical axis direction, the position detection device detects a position of the lens in the optical axis direction.

According to an embodiment of the present disclosure, there is provided a magnet to be provided in a position detection device. The position detection device performs positional detection by relatively moving a magnet and a magnetic detection device in a straight-line direction. The magnet and the magnetic detection device are arranged opposite to each other. The magnet includes periodic projections and recesses arrayed on a first surface in a relative movement direction, the first surface facing the magnetic detection device.

According to the position detection device, the image pickup apparatus, or the magnet according to the embodiment of the present disclosure, the first surface of the magnet which faces the magnetic detection device is provided with the periodic projections and recesses arrayed thereon in the relative movement direction. Consequently, the lowering of the detection precision due to the variation in the magnetized width is suppressed, as opposed to techniques in related art, so that the detection precision is enhanced.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a perspective view illustrating an appearance of an image pickup apparatus according to a first embodiment of the present disclosure, as seen from the front.

FIG. 2 is a perspective view illustrating the appearance of the image pickup apparatus illustrated in FIG. 1, as seen from the rear.

FIG. 3 is a block diagram illustrating a control system in the image pickup apparatus illustrated in FIG. 1.

FIG. 4A is a perspective view illustrating a lens barrel illustrated in FIG. 1, and FIG. 4B is a cross-sectional view schematically illustrating an internal structure of the lens barrel.

FIG. 5 is an explanatory view of a configuration of a lens guide mechanism, a lens movement mechanism, and a position detection device which are all related to a second moving lens illustrated in FIG. 4.

FIG. 6 is a schematic chart of respective detection results of two magnetic detection devices.

FIGS. 7A, 7B, and 7C are a top view, a side view, and a bottom view, respectively, of a configuration of the magnet illustrated in FIG. 5.

FIG. 8 is a cross-sectional view of the magnet taken along a line VIII-VIII of FIG. 7A.

FIGS. 9A, 9B, and 9C are a top view, a side view, and a bottom view, respectively, of a configuration of a modification example of the magnet illustrated in FIGS. 7A, 7B, and 7C.

FIGS. 10A, 10B, and 10C are a top view, a side view, and a bottom view, respectively, of a configuration of another modification example of the magnet illustrated in FIGS. 7A, 7B, and 7C.

FIGS. 11A, 11B, and 11C are a top view, a side view, and a bottom view, respectively, of a configuration of still another modification example of the magnet illustrated in FIGS. 7A, 7B, and 7C.

FIG. 12 is a graph showing a relationship between a position scale of the magnet illustrated in FIGS. 7A, 7B, and 7C and an output of a magnetic detection device.

Parts (A), (B), and (C) of FIG. 13 are a top view, a side view, and a bottom view, respectively, of a configuration of a magnet in a position detection device according to a second embodiment of the present disclosure.

FIG. 14 is a graph showing a relationship between a position scale of the magnet illustrated in FIG. 13 and an output of a magnetic detection device.

Parts (A), (B), and (C) of FIG. 15 are a top view, a side view, and a bottom view, respectively, of a configuration of a magnet in a position detection device according to a third embodiment of the present disclosure.

FIG. 16 is a graph showing a relationship between a position scale of the magnet illustrated in FIG. 15 and an output of a magnetic detection device.

FIG. 17A is a side view illustrating the configuration of the magnet of the second embodiment, and FIG. 17B is a side view illustrating a configuration of a magnet in a position detection device according to Modification example 1.

FIG. 18 is a graph showing a relationship between a position scale of the magnet illustrated in FIG. 17B and an output of a magnetic detection device.

FIG. 19A is a side view illustrating the configuration of the magnet of the second embodiment, and FIG. 19B is a side view illustrating a configuration of magnets according to Modification examples 2-1 to 2-3.

FIG. 20 is a graph showing a relationship between a position scale of the magnet according to Modification example 2-1 and an output of a magnetic detection device.

FIG. 21 is a graph showing a relationship between a position scale of the magnet according to Modification example 2-2 and an output of a magnetic detection device.

FIG. 22 is a graph showing a relationship between a position scale of the magnet according to Modification example 2-3 and an output of a magnetic detection device.

FIG. 23A is a side view illustrating the configuration of the magnet of the second embodiment, and FIG. 23B is a side view illustrating a configuration of a magnet according to Modification example 3.

FIG. 24 is a graph showing a relationship between a position scale of the magnet illustrated in FIG. 23B and an output of a magnetic detection device.

### DETAILED DESCRIPTION

Hereinafter, embodiments of the present disclosure will be described in detail, with reference to the accompanying drawings. It is to be noted that the description will be given in the following order.

1. First embodiment (an example in which: projections and recesses are alternately provided, as periodic projections and recesses, on a first surface of a magnet which faces a magnetic detection device; ribs are provided on both side edges of the first surface of the magnet; and rectangular holes are provided as the recesses)

2. Second embodiment (an example in which in the first embodiment, an inclined section and a flat section are provided in each longitudinal outer region on a second surface of the magnet)

3. Third embodiment (an example in which: grooves are provided as the recesses; and the inclined section and the flat section are provided in each longitudinal outer region on the second surface of the magnet)

4. Modification example 1 (an example in which in the second embodiment, the length of the middle region is increased)

5. Modification examples 2-1 to 2-3 (an example of a linear inclination structure in which in the second embodiment, only the inclined section is provided in each longitudinal outer region)

6. Modification example 3 (an example of a double inclination structure in which in the second embodiment, two inclined sections and a flat intermediate section therebetween are provided)

### First Embodiment

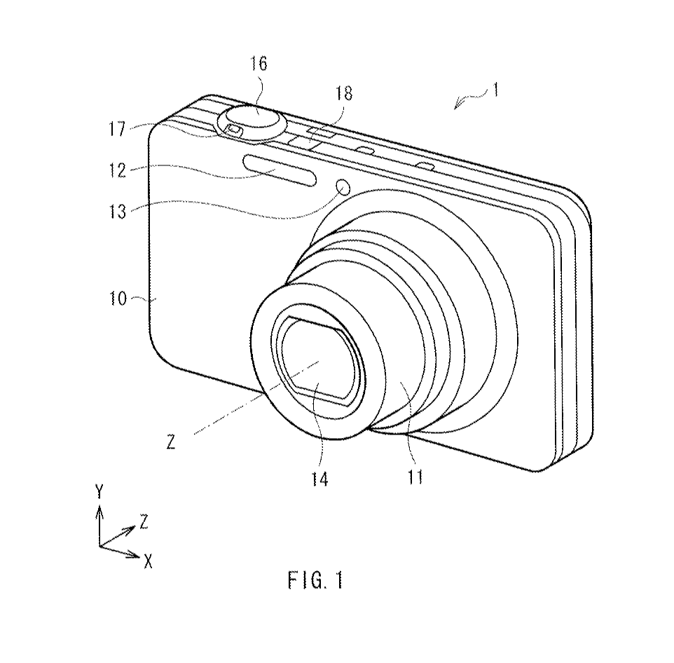

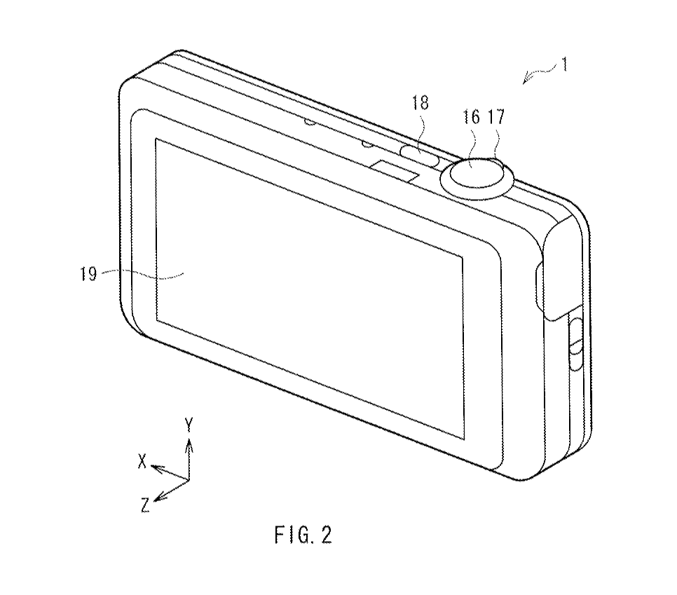

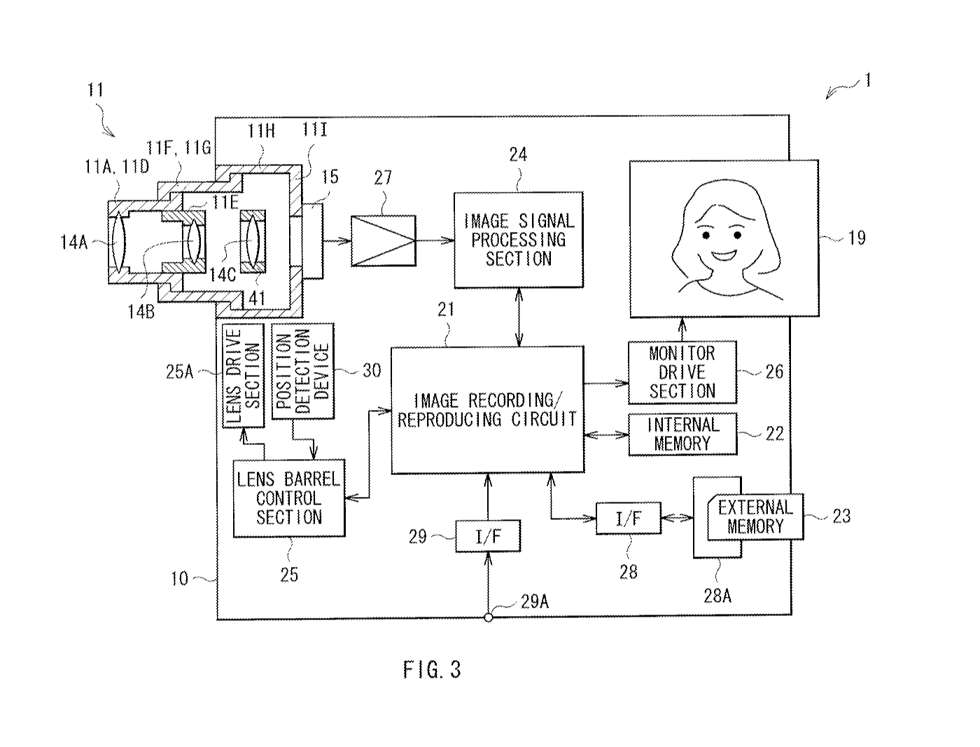

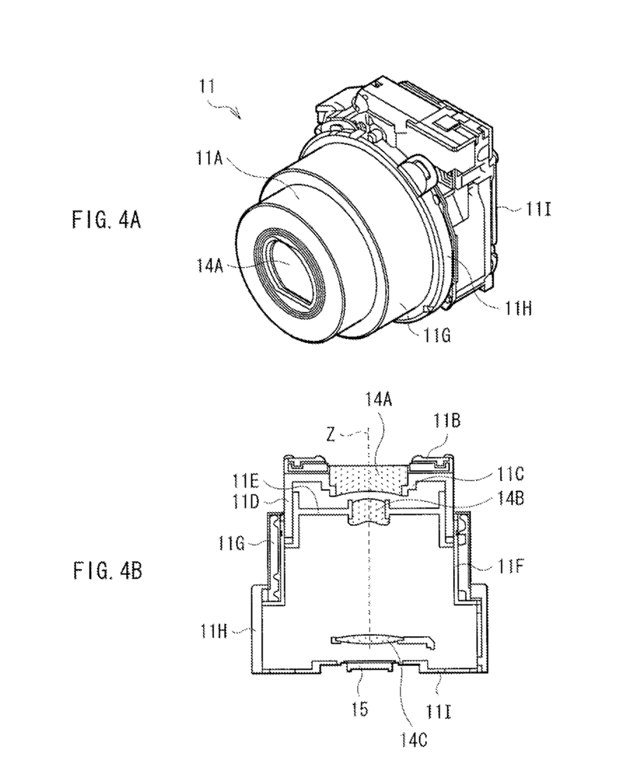

FIGS. 1 and 2 illustrate an appearance of an image pickup apparatus 1 (digital still camera) according to a first embodiment of the present disclosure, as seen from the front and rear, respectively. The image pickup apparatus 1 has a configuration, for example, where a lens barrel 11 having a collapsible mechanism is attached to a surface of a housing 10 (an exterior member) which faces a subject, namely, to the front surface of the housing 10. A flash 12 that emits assist light for capturing, and a self-timer lamp 13 are arranged in the vicinity of the lens barrel 11. An image pickup optical system 14 and an image pickup device 15 (not illustrated in FIG. 1, see FIG. 3 or 4) are arranged inside the lens barrel 11.

Herein, the “front” refers to a side facing an object or a subject in a direction along an optical axis Z of the image pickup optical system 14. The “rear” refers to a side on which an image is created or an image pickup device 15 is disposed.

The image pickup optical system 14 is configured to be moved by a lens drive section 25A (not illustrated in FIG. 1, see FIG. 3) built into the housing 10. Specifically, the image pickup optical system 14 is movable along the optical axis Z between a capturing position (a wide-angle state, a telephoto state, or an intermediate state therebetween) and an accommodated position (collapsed position). In the capturing position, the image pickup optical system 14 protrudes forwardly from the front surface of the housing 10, and in the accommodated position, the image pickup optical system 14 is embedded in the front surface of the housing 10. The image pickup device 15 captures an image of a subject formed by the image pickup optical system 14, and includes, for example, charge coupled devices (CCD) or CMOS image sensors.

The upper surface of the housing 10 is provided with, for example, a shutter button 16 used to capture an image, a zoom operation lever 17 used to adjust a zoom of the image pickup optical system 14, and a power button 18.

The rear surface of the housing 10 is provided with, for example, a display section 19 having a touch panel function for menu selection. Optionally, an operation switch for menu selection (not illustrated) may be provided independently of the display section 19, in place of the touch panel function of the display section 19.

FIG. 3 illustrates a control system of the image pickup apparatus 1. The image pickup apparatus 1 includes, for example, the lens barrel 11, the display section 19, an image recording/reproducing circuit 21, an internal memory 22, an external memory 23, an image signal processing section 24, a lens barrel control section 25, a monitor drive section 26, an amplifier 27, a first interface 28, and a second interface 29.

The image recording/reproducing circuit 21 has, for example, an arithmetic circuit with a microcomputer (central processing unit (CPU)). In addition, the image recording/reproducing circuit 21 controls the image signal processing section 24, the monitor drive section 26, and the lens barrel control section 25, according to an operation with the shutter button 16, the zoom operation lever 17, the power button 18, the touch panel of the display section 19, or the like. The image recording/reproducing circuit 21 is connected to the internal memory 22, the image signal processing section 24, the lens barrel control section 25, the monitor drive section 26, the amplifier 27, the first interface (I/F) 28, and the second interface (I/F) 29.

The internal memory 22 includes, for example, in addition to a program memory and a data memory that are used to drive the image recording/reproducing circuit 21, a random access memory (RAM) and a read only memory (ROM). The external memory 23 is used to expand the total memory capacity.

The image signal processing section 24 generates image data, based on a captured image signal outputted from the image pickup device 15, and enters the generated image data into the image recording/reproducing circuit 21. The image signal processing section 24 is connected to the image pickup device 15 attached to the lens barrel 11 through the amplifier 27.

The lens barrel control section 25 controls the driving of the lens barrel 11. The lens barrel control section 25 is connected to the lens drive section 25A and a position detection device 30. The lens drive section 25A performs zoom operation and focus operation of the lens barrel 11. The position detection device 30 detects a position of a lens in the image pickup optical system 14, and supplies the detection result to the lens barrel control section 25. The detail of the position detection device 30 will be described later.

The display section 19 is connected to the image recording/reproducing circuit 21 through the monitor drive section 26. The monitor drive section 26 displays image data on the display section 19.

The first interface 28 is connected to a connector 28A, and the external memory 23 is detachably connectable to the first interface 28. The second interface 29 is connected to a connection terminal 29A provided in the housing 10.

FIG. 4A illustrates an appearance of the lens barrel 11 illustrated in FIG. 1 in a protruding state, and FIG. 4B illustrates an internal configuration of the lens barrel 11. The lens barrel 11 includes a decorative ring 11A, a barrier unit 11B, a first lens frame 11C, a first moving frame 11D, a second moving frame 11E, a linear movement guide ring 11F, a rotation ring 11G, a fixed ring 11H, and a rear barrel 11I, in this order of closeness to a subject. The image pickup optical system 14 includes, for example, a first lens group 14A, a second lens group 14B, and a third lens group 14C along the optical axis Z, in this order from the front (subject side) to the rear.

The fixed ring 11H is fixed to the housing 10. The rear barrel 11I is detachably fixed to the rear of the fixed ring 11H with a plurality of fastening screws (not illustrated). The rear barrel 11I is provided with a substantially quadrangular through-hole at the center thereof, and the image pickup device 15 is attached to the through-hole.

The rotation ring 11G is rotatable around the optical axis Z relative to the fixed ring 11H, and is linearly movable in the direction along the optical axis Z relative thereto. In more detail, the rotation ring 11G has a gear train (not illustrated) on the outer periphery thereof, and is rotatable around the optical axis Z by the driving of a drive motor (not illustrated) fixed between the fixed ring 11H and the rear barrel 11I. In addition, the rotation ring 11G is provided with three cam pins (not illustrated), and the cam pins engage with three corresponding cam grooves (not illustrated) provided on the inner periphery of the fixed ring 11H. Accordingly, the rotation ring 11G is movable in the direction along the optical axis Z along tracks formed by the cam grooves of the fixed ring 11H, along with the relative rotation of the rotation ring 11G to the fixed ring 11H.

The linear movement guide ring 11F is permitted only to linearly move relative to the fixed ring 11H in the direction along the optical axis Z without rotating relative thereto. In more detail, the linear movement guide ring 11F has five projections (not illustrated) to fit into the fixed ring 11H, and the projections engage with five corresponding straight grooves (not illustrated) provided in the fixed ring 11H. As a result, the linear movement guide ring 11F is permitted only to move in the direction along the optical axis Z relative to the fixed ring 11H, and movement of the linear movement guide ring 11F is restricted in a rotational direction.

When the rotation ring 11G and the linear movement guide ring 11F are bayonet-coupled to each other in the above-described manner, the linear movement guide ring 11F is permitted to linearly move without any suppression from the rotation of the rotation ring 11G. Moreover, when the rotation ring 11G moves in the direction along the optical axis Z, the linear movement guide ring 11F moves integrally with the rotation ring 11G.

The first lens frame 11C holds the first lens group 14A, and is held by the first moving frame 11D. The first moving frame 11D moves the first lens frame 11C. The second moving frame 11E moves the second lens group 14B while holding it.

Each of the first moving frame 11D and the second moving frame 11E is permitted only to linearly move in the direction along the optical axis Z relative to the fixed ring 11H without rotating relative thereto. Specifically, each of the first moving frame 11D and the second moving frame 11E is provided with three cam pins (not illustrated). The cam pins engage with three corresponding cam grooves (not illustrated) provided on the inner periphery of the rotation ring 11G. Furthermore, each of the first moving frame 11D and the second moving frame 11E also engages with straight grooves (not illustrated) of the linear movement guide ring 11F, so as not to rotate in conjunction with the rotation of the rotation ring 11G.

The barrier unit 11B closes an optical path, or a photographing opening, when photographs are not taken, in order to protect the image pickup optical system 14.

The cosmetic ring 11A is fixed to the first moving frame 11D, in order to improve the appearance of the lens barrel 11 and protect the barrier unit 11B. Any kind of metal, such as aluminum alloy and stainless steel is suitable for a material of the cosmetic ring 11A, but an engineering plastic may also be used therefor.

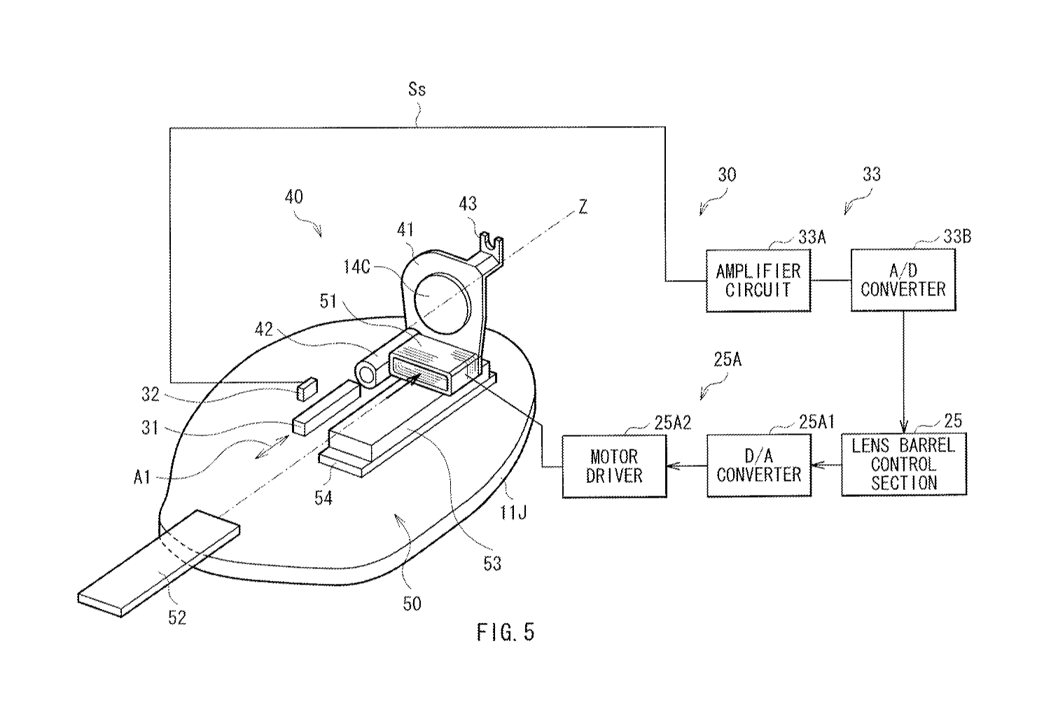

FIG. 5 is an explanatory view of a configuration of the lens guide mechanism 40, the lens movement mechanism 50, and the position detection device 30, which are all related to the third lens group 14C illustrated in FIG. 4.

The lens guide mechanism 40 supports the third lens group 14C on a base 11J fixed to the fixed ring 11H, so as to allow the third lens group 14C to be movable in the direction along the optical axis Z. The lens guide mechanism 40 includes, for example, a lens holding frame 41, a sleeve section 42, a groove section 43, a first guide spindle (not illustrated), and a second guide spindle (not illustrated). The lens holding frame 41 is a ring-shaped member that holds the third lens group 14C. Both the sleeve section 42 and the groove section 43 are provided in the outer region of the lens holding frame 41. The first and second guide spindles (not illustrated) are disposed to pass through the sleeve section and the groove section 43, respectively while being parallel to the optical axis Z. This enables the third lens group 14C held by the lens holding frame 41 to linearly reciprocate along the optical axis Z.

The lens movement mechanism 50 includes, for example, a driving coil 51, an opposed yoke 52, a driving magnet 53, and a ground yoke 54. The driving coil 51 is formed by winding a wire around an imaginary axis parallel to the optical axis Z, and is secured to the lens holding frame 41 with, for example, an adhesive. The inner periphery of the driving coil 51 is opened in front-and-rear directions. The opposed yoke 52 has a rectangular-plate shape, and is loosely inserted into the inner periphery of the driving coil 51, so as to be disposed parallel to the optical axis Z. The driving magnet 53 has a rectangular-plate shape, and is disposed on the outer periphery of the driving coil 51 while being parallel to the opposed yoke 52. The ground yoke 54 has a rectangular-plate shape which is substantially the same as that of the driving magnet 53, and is provided between the driving magnet 53 and the base 11J.

The lens movement mechanism 50 is driven by the lens drive section 25A (see FIG. 3). The lens drive section 25A includes a D/A convertor 25A1 and a motor driver 25A2, as illustrated in FIG. 5. The D/A convertor 25A1 D/A-converts a drive signal in a digital format that is supplied from the lens barrel control section 25 (see FIG. 3). The motor driver 25A2 supplies a drive current to the driving coil 51, based on a drive signal in an analog format that is supplied from the D/A convertor 25A1. This enables the lens movement mechanism 50 to move the lens holding frame 41 in a direction along the optical axis Z, by a magnetic interaction between a magnetic field generated by the driving magnet 53 and a magnetic field generated by the driving coil 51 based on the drive current from the lens drive section 25A.

The position detection device 30 includes, for example, a positional detection magnet 31 (hereinafter, referred to as simply “magnet 31”), a magnetic detection device 32, and a positional information generating section 33.

The magnet 31 and the magnetic detection device 32 are arranged opposite to each other, so as to be relatively movable in a straight-line direction. In more detail, the magnet 31 is held by, for example, a holding member (not illustrated) secured to the sleeve section 42, and is linearly movable in the direction along the optical axis Z, together with the third lens group 14C, or a target for positional detection, and the lens holding frame 41. On the other hand, the magnetic detection device 32 is fixed to the base 11J by a holding member (not illustrated) while facing the magnet 31.

The magnetic detection device 32 generates a detection signal (position signal) Ss of a level corresponding to the strength of a magnetic force generated between the poles of the magnet 31. For example, the magnetic detection device 32 may be a Hall device. Since a Hall device generates a voltage proportional to a magnetic flux density, the detection signal Ss outputted from the Hall device has a voltage corresponding to (or proportional to) the strength of an exerted magnetic force (or the magnitude of the magnetic flux density). If a distance between the magnet 31 and the magnetic detection device 32 is adjusted appropriately, the detection signal Ss outputted from the magnetic detection device 32 becomes a substantially sinusoidal signal. It is to be noted that the magnetic detection device 32 is not limited to a Hall device. The magnetic detection device 32 may be any given device as long as it detects the strength of a magnetic force and generates the detection signal Ss. For example, the magnetic detection device 32 may be an MR device.

Although it is not illustrated, it is preferable that the magnetic detection device 32 be composed of two device units arranged along a relative movement direction A1 in which the magnetic detection device 32 and the magnet 31 move relative to each other. As illustrated in FIG. 6, by outputting respective substantially sinusoidal signals with different phases (first phase S1 and second phase S2), from the two device units of the magnetic detection device 32, it is possible to determine a direction in which the third lens group 14C moves.

The positional information generating section 33 includes, for example, an amplifier circuit 33A and an A/D convertor 33B. The amplifier circuit 33A amplifies the detection signal Ss from the magnetic detection device 32. The A/D convertor 33B converts the detection signal Ss in an analog format which has been amplified by the amplifier circuit 33A into a detection signal Ss in a digital format, and then supplies the converted detection signal Ss to the lens barrel control section 25 as positional information regarding the third lens group 14C. As a result, the lens barrel control section 25 detects a position of the third lens group 14C in the direction along the optical axis Z, based on the detection signal Ss. Then, the lens barrel control section 25 supplies a drive signal to the lens drive section 25A, according to the detection result, thereby controlling the position of the third lens group 14C in the direction along the optical axis Z and the closed loop of, for example, a servomechanism.

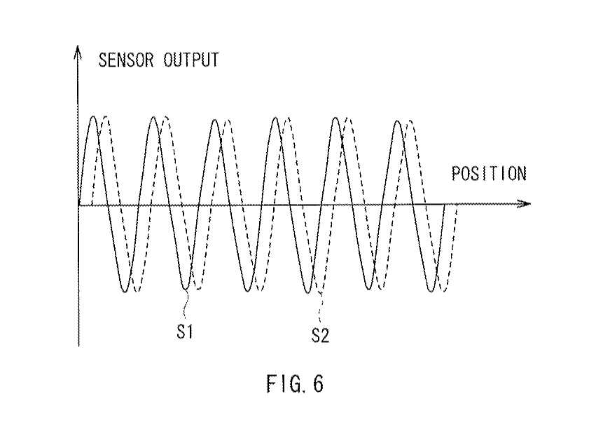

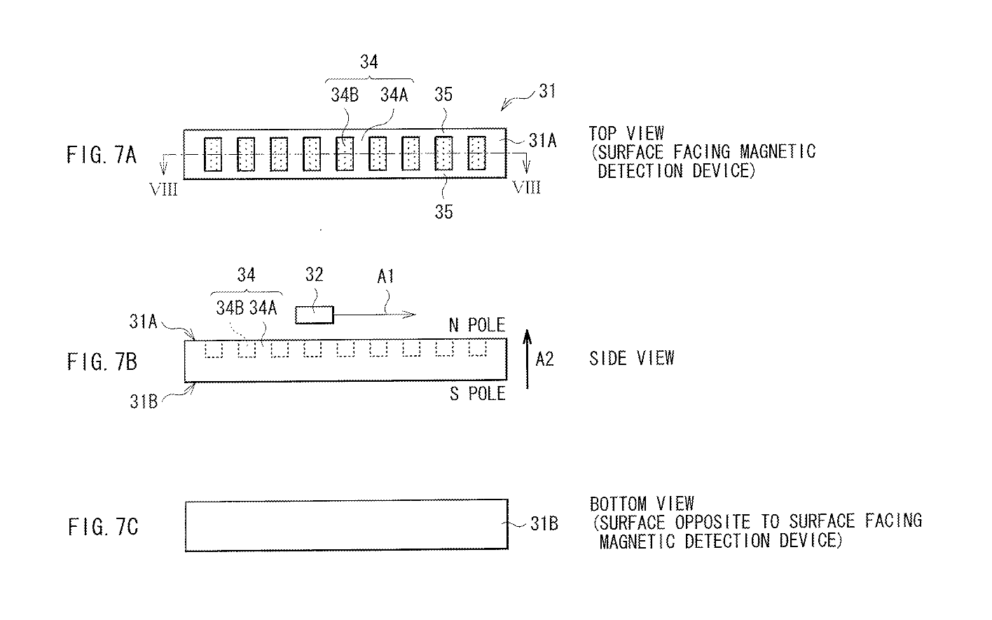

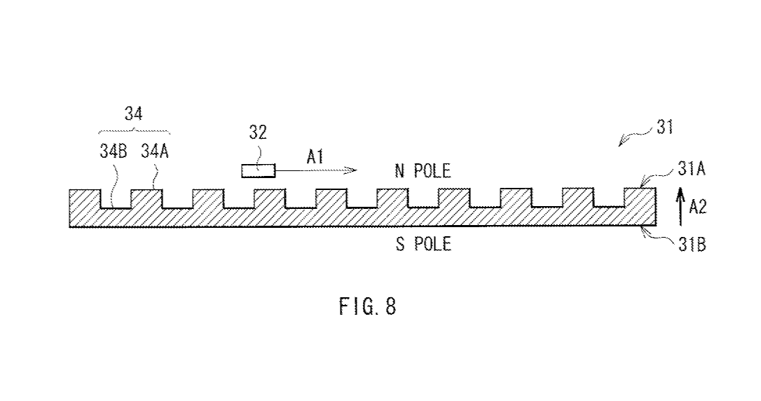

FIGS. 7A, 7B, and 7C illustrate a configuration of the magnet 31 illustrated in FIG. 5. FIG. 8 illustrates a cross section of the magnet 31 taken along a line VIII-VIII of FIG. 7A. The magnet 31 is a rectangular parallelepiped, bar-shaped member that linearly extends in the relative movement direction A1. The magnet 31 has a first surface 31A facing the magnetic detection device 32, and on the first surface 31A, periodic projections and recesses 34 are arrayed in the relative movement direction A1. With the periodic projections and recesses 34 in the image pickup apparatus 1, the lowering of the detection precision due to the variation in the magnetized width is suppressed, as opposed to techniques in related art. Therefore, the detection precision is enhanced.

It is preferable that the magnet 31 be formed of, for example, a resin magnet. In this case, it is possible to mold the magnet 31 precisely at a low cost by employing an injection molding method. Further, a variation in the period of the sinusoidal output signal is reduced, thereby being able to provide more precise positional detection than a magnet formed with a magnetization method of the related art does. Furthermore, a complex, expensive magnetizing device, such as that for use in related art, is made unnecessary, and thus the cost reduction in the magnet 31 is achievable. Alternatively, the magnet 31 may be formed of a ferrite magnet.

It is preferable that the magnet 31 be magnetized in a single direction from a second surface 31B to the first surface 31A as an arrow A2 illustrated in FIG. 7B or 8, or from the first surface 31A to the second surface 31B (not illustrated). This enables the magnetization process to be performed easier than that in the case in which the magnetic poles of a magnet alternating along the movement direction as in related art. Thus, if the first surface 31A is an N pole, the second surface 31B becomes an S pole, as illustrated in FIGS. 7B and 8. Otherwise, if the first surface 31A is an S pole, the second surface 31B becomes an N pole (not illustrated). As described above, the magnetizing direction A2 of the magnet 31 is parallel to the direction in which the magnet 31 faces the magnetic detection device 32, and is vertical to the relative movement direction A1.

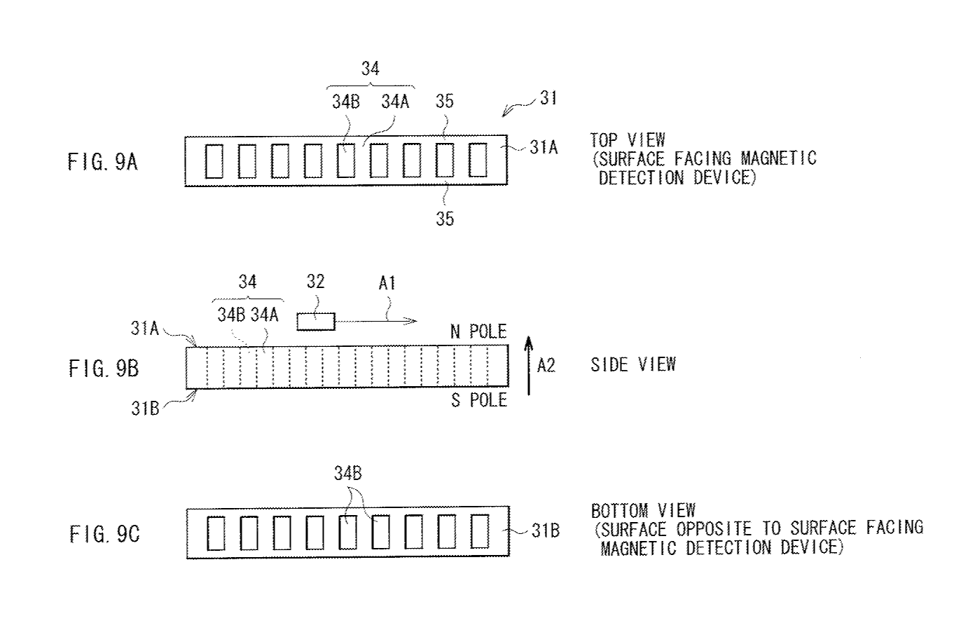

The magnet 31 has projections 34A and recesses 34B arranged alternately, as the periodic projections and recesses 34. The recesses 34B are depressions, more specifically, rectangular holes formed at regular intervals in the relative movement direction A1, for example, as illustrated in FIGS. 7A, and 8. The longer side of each of the projections 34A and the recesses 34B is vertical to the relative movement direction A1. Alternatively, each of the recesses 34B may be a through-hole (namely, the depth of each of the recesses 34B is equal to the thickness of the magnet 31), for example, as illustrated in FIG. 9.

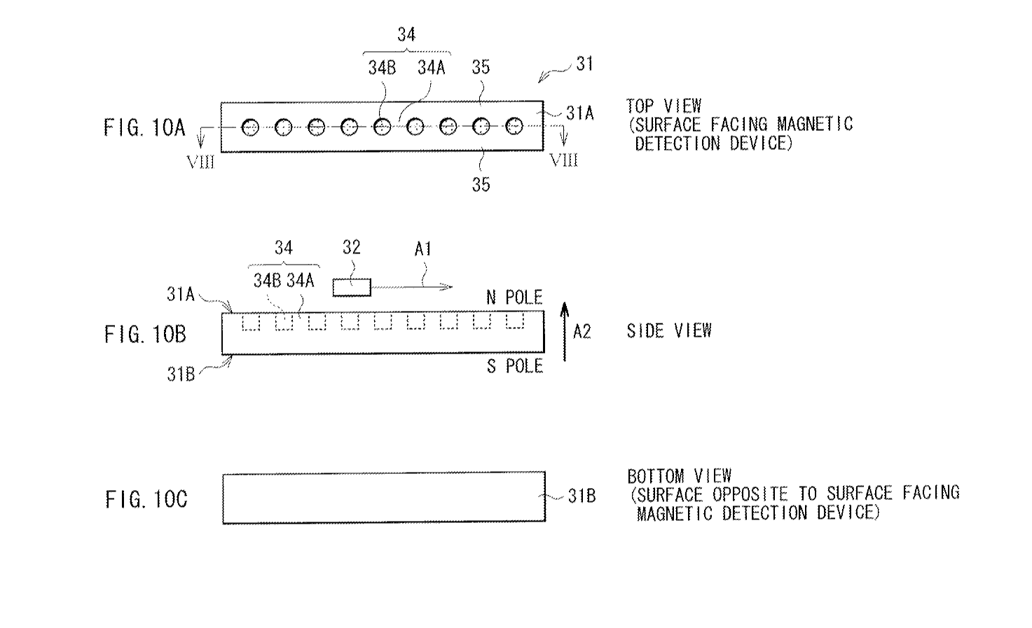

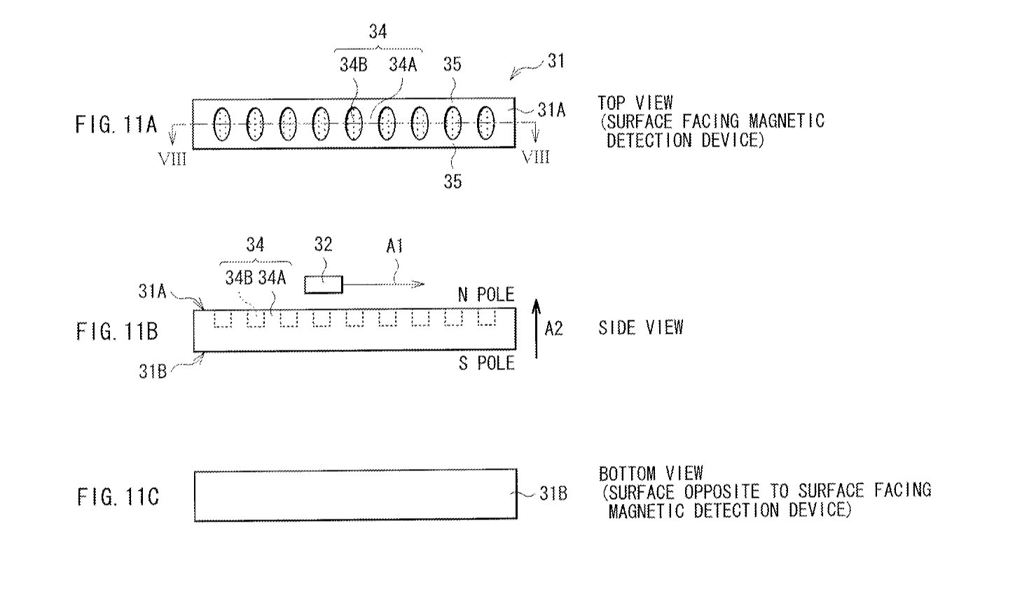

The planar shape of each of the periodic projections and recesses 34 is not limited to rectangular as illustrated in FIGS. 7A, and 8, but may be circular, elliptic, or other shapes as illustrated in FIG. 10 or 11.

It is preferable that the periodic projections and recesses 34 include a starting projection at the end of the magnet in the relative movement direction A1. With this arrangement, the waveform is less distorted at the ends thereof. In the cases of FIGS. 7A to 11C, for example, nine and a half periods of periodic projection and recess 34 and nine recesses 34B are provided. However, there is no limitation on the number of periods of the periodic projection and recess 34 and the number of the recesses 34B. They may be varied as appropriate, according to a distance over which the image pickup optical system 14 moves.

It is preferable that the magnet 31 be provided with ribs 35 on both side edges of the first surface 31A. Providing the ribs 35 reduces the warping of the magnet 31 due to the expansion and contraction of the resin upon molding, thus achieving the more precise positional detection. It is preferable that the ribs 35 be provided on both side edges of the first surface 31A, as illustrated in FIG. 7A, but the single rib 35 may be provided on either of the two side edges of the first surface 31A. Alternatively, holes with a depth the same as that of each of the recesses 34B may be provided on the second surface 31B, in place of the ribs 35. Even in this case, the same effect is attained.

The magnet 31, as described above, may be manufactured through the following processes. First, a magnetic powder is set in a die (not illustrated), and is molded and sintered by an injection molding method. Subsequently, the resulting body is magnetized with an air core coil. In the first embodiment, the magnet 31 is manufactured through a molding process using a die, and the magnetizing process is easily performed. Therefore, it is possible to produce the positional detection magnet 31 at a lower cost and with a smaller range of variation than a magnet, as in related art, which is magnetized to have the magnetic poles alternating along the relative movement direction.

In the image pickup apparatus 1, the lens barrel control section 25 drives the lens drive section 25A according to an operation with the zoom operation lever 17. Then, the third lens group 14C of the image pickup optical system 14 is moved in the direction along the optical axis Z. Accordingly, the magnet 31 of the position detection device 30 linearly moves relative to the magnetic detection device 32 in the direction along the arrow A1, together with the third lens group 14C that is a target for positional detection. Then, the magnetic detection device 32 detects a magnetic field on the first surface 31A of the magnet 31 which faces the magnetic detection device 32.

In this case, the first surface 31A of the magnet 31 is provided with the periodic projections and recesses 34 arrayed thereon in the relative movement direction A1. With the periodic projections and recesses 34, the lowering of the detection precision due to the variation in the magnetized width is suppressed, as opposed to techniques of the related art. Therefore, the detection precision is enhanced.

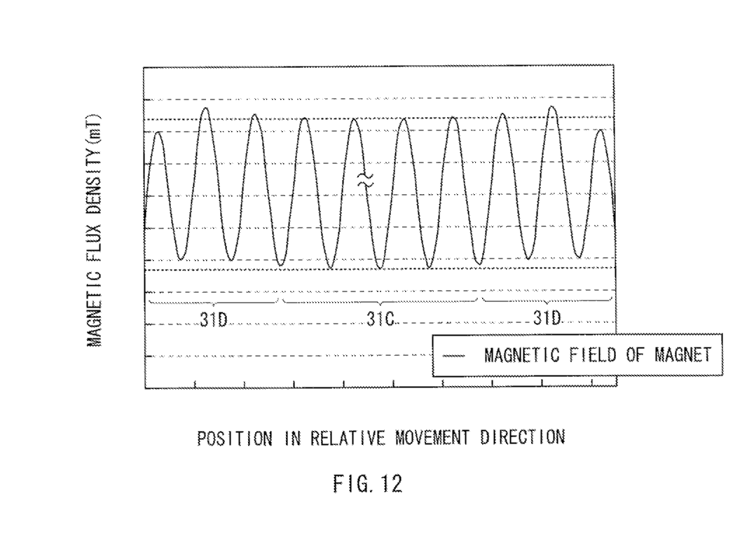

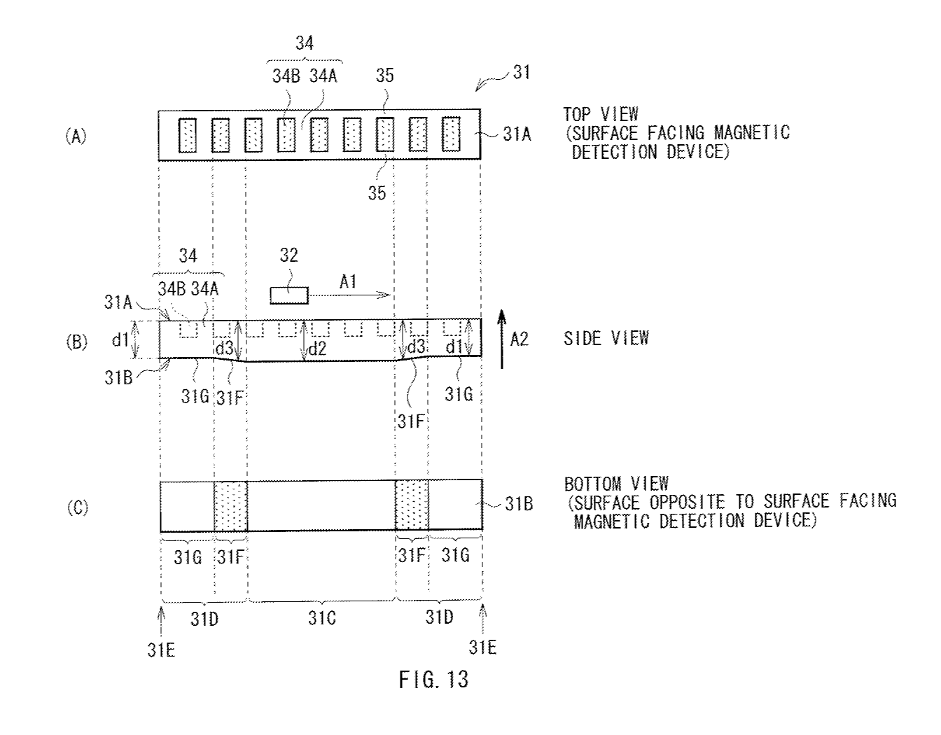

FIG. 12 schematically shows a measurement result of a magnetic field on the first surface 31A of the magnet 31. In this measurement, a Hall device was used as the magnetic detection device 32, and a magnetic flux density that was vertical to the first surface 31A was detected.

As seen from FIG. 12, a proper, substantially sinusoidal output was obtained from a middle region 31C of the magnet 31 in the relative movement direction A1. In contrast, the output waveform was distorted at each outer region 31D outside the middle region 31C. However, when a sufficient margin is provided in each outer region 31D, it is possible to use only the middle region 31C, in which the output is a substantially sinusoidal waveform, for positional detection.

As described above, in the first embodiment, the first surface 31A of the magnet 31 is provided with the periodic projections and recesses 34 arrayed in the relative movement direction A1. With the periodic projections and recesses 34, the lowering of the detection precision due to the variation in the magnetized width is suppressed, as opposed to techniques of the related art. Consequently, the detection precision is enhanced.

### Second Embodiment

Parts (A), (B), and (C) of FIG. 13 illustrate a configuration of a magnet 31 in a position detection device 30 according to a second embodiment of the present disclosure. In the second embodiment, the thickness of the magnet 31 in the middle thereof is set larger than that at each end thereof, in the relative movement direction A1. Aside from this, the magnet 31 according to the second embodiment has the same configuration as the first embodiment does. In addition, the magnet 31 of the second embodiment may be manufactured through the same process as that of the first embodiment. Accordingly, in the following description, the same reference numerals are assigned to components corresponding to those of the first embodiment.

The magnet 31 includes a middle region 31C disposed in the middle of the magnet 31 along the relative movement direction A1, and outer regions 31D arranged on the respective outer sides of the middle region 31C. A thickness d2 of the middle region 31C is uniform.

The thickness d2 of the magnet 31 in the middle thereof along the relative movement direction A1 (namely, the thickness d2 of the middle region 31C) is larger than a thickness d1 at each end 31E thereof along the relative movement direction A1. With this configuration, in the second embodiment, increase in permeance in each outer region 31D is suppressed, when the magnet 31 and the magnetic detection device 32 move relative to each other. This makes it possible to obtain the proper, substantially sinusoidal output from not only the middle region 31C but also each of the outer regions 31D.

Specifically, each of the outer regions 31D on the second surface 31B includes an inclined section 31F inclined with respect to the relative movement direction A1. It is preferable that a thickness d3 of each inclined section 31F be increased toward the middle region 31C. With this inclined section 31F, an effect of improving the distortion of an output waveform from each outer region 31D is further enhanced.

Herein, each of the thicknesses d1, d2, and d3 refers to a thickness of the magnet 31 in the magnetizing direction A2, namely, a distance between the second surface 31B and the projection 34A of the periodic projection and recess 34.

It is preferable that each outer region 31D on the second surface 31B have the inclined section 31F and a flat section 31G in this order of closeness to the middle region 31C. Providing the flat sections 31G facilitates the positioning of the magnet 31 during an attachment process and to improve the precision with which the magnet 31 is molded.

The magnetic detection device 32 and the positional information generating section 33 are configured to be the same as those in the above-described first embodiment.

In the image pickup apparatus 1, the lens barrel control section 25 drives the lens drive section 25A according to an operation with the zoom operation lever 17. Then, the third lens group 14C of the image pickup optical system 14 is moved in the direction along the optical axis Z. Accordingly, the magnet 31 of the position detection device 30 linearly moves relative to the magnetic detection device 32 in a direction of the arrow A1, together with the third lens group 14C that is a target for positional detection. As a result, the magnetic detection device 32 detects a magnetic field on the first surface 31A of the magnet 31 which faces the magnetic detection device 32.

In this case, since the thickness d2 of the magnet 31 in the middle thereof (the middle region 31C) is larger than the thickness d1 at each end 31E thereof, increase in permeance in each outer region 31D is suppressed, when the magnet 31 and the magnetic detection device 32 move relative to each other. This makes it possible to obtain the proper, substantially sinusoidal output from not only the middle region 31C but also each outer region 31D.

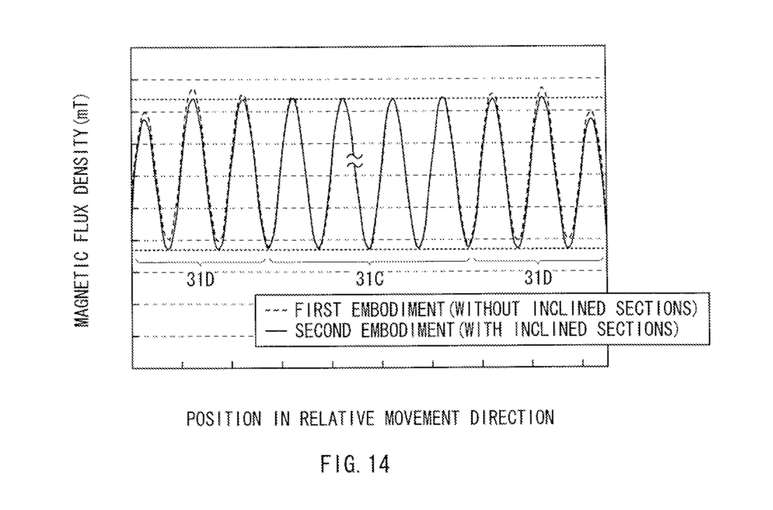

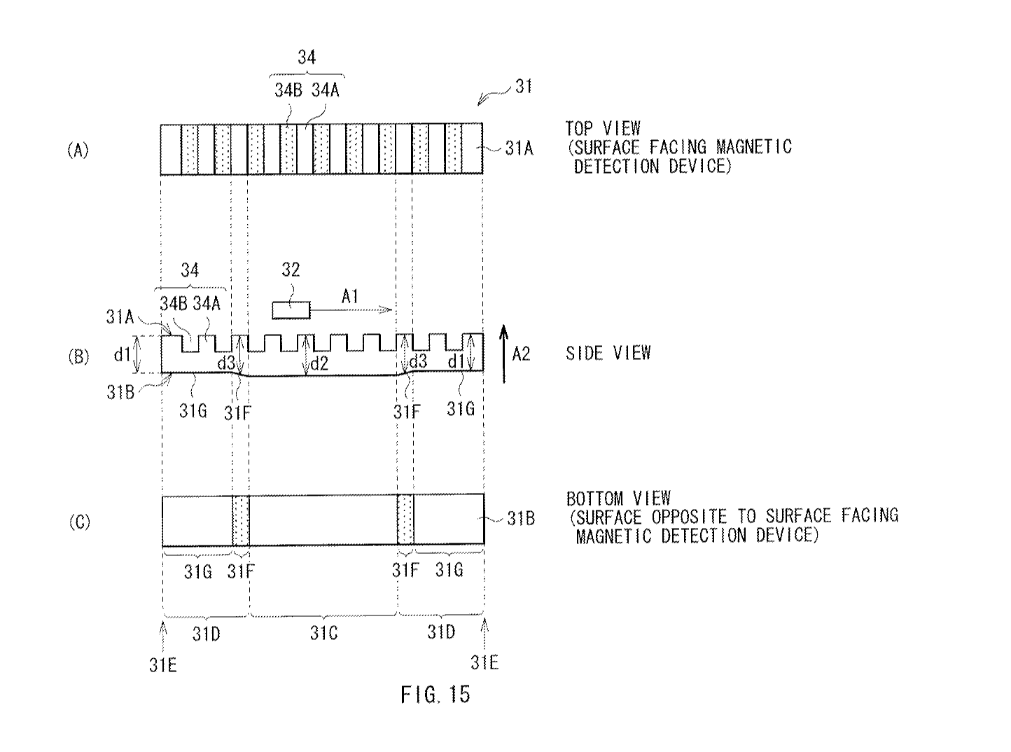

FIG. 14 schematically shows a measurement result of a magnetic field on the first surface 31A of the magnet 31. In this measurement, a Hall device was used as the magnetic detection device 32, and a magnetic flux density that was vertical to the first surface 31A was detected. Moreover, the periodic projections and recesses 34 included a starting projection 34A at the end of the magnet 31 in the relative movement direction A1. Each flat section 31G was provided so as to face a projection 34A and a recess 34B of a first period and a projection 34A of a second period, with respect to the corresponding starting projection 34A. In addition, each inclined section 31F was provided so as to face a recess 34B of the second period and a projection 34A of a third period, with respect to the corresponding starting projection 34A. It is to be noted that FIG. 14 also shows the measurement result of the first embodiment illustrated in FIG. 12.

It is found from FIG. 14 that in the first embodiment, the amplitude and a midpoint of the amplitude of the output waveform in the vicinity of the third period from each end starts being varied in comparison with those of the middle region 31C. In contrast, it is found that in the second embodiment, the amplitudes and midpoints of the amplitudes of the output waveform are substantially constant between the 0.5th periods from the respective ends. Consequently, the second embodiment enables the total length of the magnet 31 to be decreased by a length corresponding to five periods (2.5 periods×both ends=5 periods).

Incidentally, a rotational angle detection method is known, which utilizes a variation in magnetism generated by the projections and recesses of a toothed wheel, as described in Japanese Unexamined Patent Application Publication No. 2003-180672 (FIG. 4). However, in the case where linear movement is detected using the projections and recesses of the toothed wheel described in this document, in place of rotational movement, a fragment of the ring-shaped toothed wheel is extracted and flattened to be used as a magnet or a magnetic unit of a limited length. In this case, disadvantageously, the magnetic field on the magnet or the magnetic unit of a limited length may be distorted in both outer regions thereof. Therefore, there are cases where an output signal from a sensor equipped with such a magnet or such a magnetic unit is distorted in both outer regions of the stroke. As a result, a margin with a sufficient length is provided in each outer region of the magnet or the magnetic unit, and only a region of the magnet or the magnetic unit in which the output waveform is not distorted is utilized. In this case, it may be necessary to increase the magnet or the magnetic unit in length, and if a lens barrel is equipped with this position detection device, the lens barrel is prone to being enlarged in a direction along an optical axis.

In contrast, in the second embodiment, the thickness d2 of the magnet 31 in the middle thereof (the middle region 31C) is larger than the thickness d1 at each end 31E thereof, in the relative movement direction A1, thereby reducing the distortion of the output waveform from each outer region 31D of the magnet 31. Consequently, it is possible to decrease the total length of the magnet 31 by reducing the margin of each outer region 31D of the magnet 31, and therefore it is possible to reduce the size of the magnet 31 in the relative movement direction A1. Furthermore, since the respective total lengths of the position detection device 30 and the lens barrel 11 equipped with the above position detection device 30 are decreased in a direction along an optical axis, it is also possible to provide the compact and thin image pickup apparatus 1.

As described above, in the second embodiment, the thickness d2 of the magnet 31 in the middle thereof (the middle region 31C) is larger than the thickness d1 at each end 31E thereof, by providing each outer region 31D in the second surface 31B with the inclined section 31F and the flat section 31G. This makes it possible to obtain proper, substantially sinusoidal output from not only the middle region 31C of the magnet 31 but also each outer region 31D thereof. Furthermore, it is achieved that the total length of the magnet 31 is decreased. This configuration is advantageous in terms of miniaturizing both the position detection device 30 and the lens barrel 11, more specifically, decreasing the thickness of the image pickup apparatus 1.

The description of the second embodiment has been given regarding to the case where the inclined section 31F and the flat section 31G are provided in the outer region 31D of the second surface 31B, so that the thickness d2 of the magnet 31 in the middle thereof (the middle region 31C) is larger than the thickness d1 at each end 31E thereof in the relative movement direction A1. However, another configuration, such as that where the recesses 34B in each outer region 31D are formed more deeply, may be employed, in order to cause the thickness d2 of the magnet 31 in the middle thereof (the middle region 31C) to be larger than the thickness d1 at each end 31E thereof in the relative movement direction A1.

### Third Embodiment

Parts (A), (B), and (C) of FIG. 15 illustrate a configuration of a magnet 31 of a position detection device 30 according to a third embodiment of the present disclosure. Except that the periodic projections and recesses 34 include, as recesses, grooves provided across the first surface 31A in a direction along the width of the first surface 31A, the magnet 31 according to the third embodiment has a similar configuration to that of the second embodiment. In addition, the magnet 31 according to the third embodiment may be manufactured through the same process as the first embodiment. Accordingly, in the following description, the same reference numerals are assigned to components corresponding to those of the first or second embodiment.

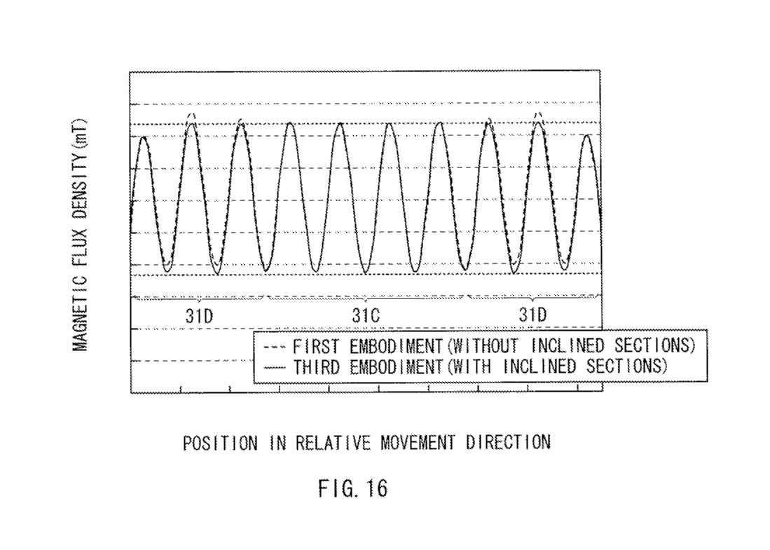

FIG. 16 schematically shows a measurement result of a magnetic field on the first surface 31A of the magnet 31. In this case, a Hall device was used as the magnetic detection device 32, and a magnetic flux density that was vertical to the first surface 31A was detected. Moreover, the periodic projections and recesses 34 included a starting projection 34A at the end of the magnet 31 in the relative movement direction A1. Each flat section 31G was provided so as to face projections 34A and recesses 34B of first and second periods, with respect to the corresponding starting projection 34A, and each inclined section 31F was provided so as to face a projection 34A of the third period. It is to be noted that FIG. 16 also shows the measurement result of the first embodiment illustrated in FIG. 12.

It is found from FIG. 16 that in the first embodiment, the amplitude and a midpoint of the amplitude of the output waveform in the vicinity of the third period from each end starts being varied in comparison with those of the middle region 31C. In contrast, it is found that in the third embodiment, the amplitudes and midpoints of the amplitudes of the output waveform are substantially constant between the 0.5th periods from the respective ends. Consequently, the third embodiment enables the total length of the magnet 31 to be decreased by a length corresponding to five periods (2.5 periods×both ends=5 periods). Thus, since the respective total lengths of the position detection device 30 and the lens barrel 11 equipped with the above position detection device 30 are decreased in a direction along an optical axis, it is possible to provide the compact and thin image pickup apparatus 1.

As described above, in the third embodiment, the thickness d2 of the magnet 31 in the middle thereof (the middle region 31C) is larger than the thickness d1 at each end 31E thereof, similar to the second embodiment. This makes it possible to obtain proper, substantially sinusoidal output from not only the middle region 31C of the magnet 31 but also each outer region 31D thereof. Accordingly, it is achieved that the total length of the magnet 31 is decreased. This configuration is advantageous in terms of miniaturizing both the position detection device 30 and the lens barrel 11, more specifically, decreasing the thickness of the image pickup apparatus 1.

Hereinafter, description will be given of Modification examples 1 to 3 of the present disclosure. All of Modification examples 1 to 3 are based on the magnet 31 of the above-described second embodiment.

### Modification Example 1

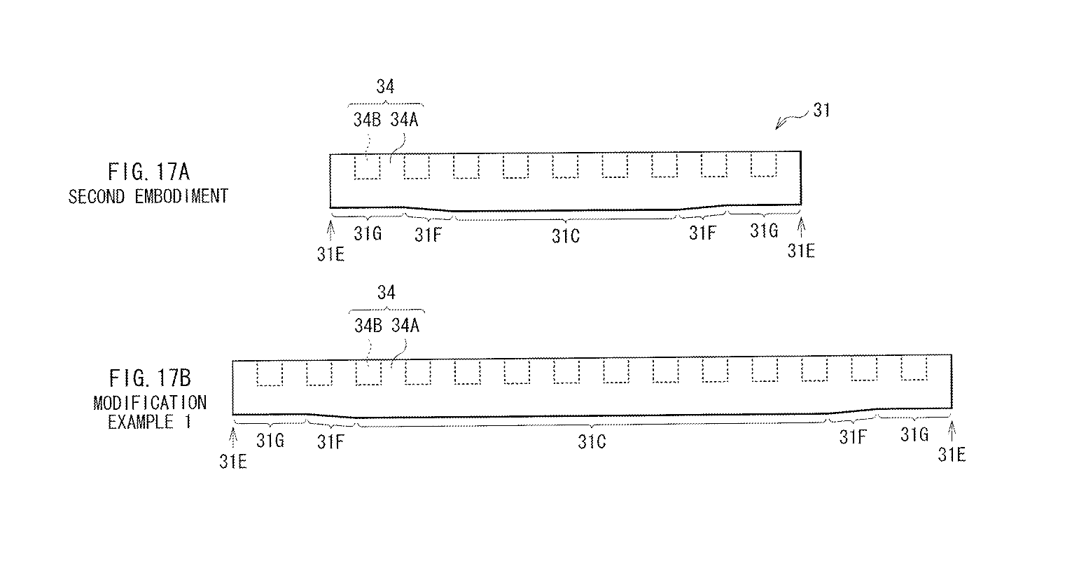

FIG. 17A illustrates the configuration of the magnet of the second embodiment, and FIG. 17B illustrates a configuration of a magnet 31 according to Modification example 1. Except that the length of the middle region 31C is increased by approximately half from the length of the magnet 31 of the second embodiment, this modification example has a similar configuration as that of the second embodiment. In addition, the magnet 31 according to the modification example may be manufactured through the same process as the first embodiment is. Accordingly, in the following description, the same reference numerals are assigned to components corresponding to those of the first or second embodiment.

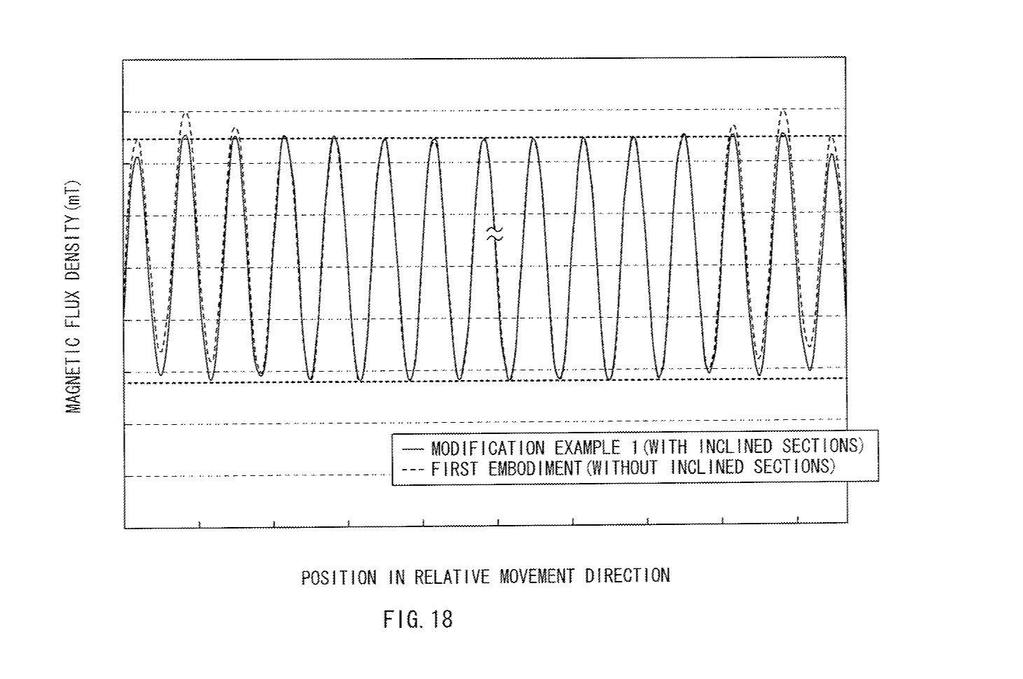

FIG. 18 schematically shows a measurement result of a magnetic field on the first surface 31A of the magnet 31. In this measurement, a Hall device was used as the magnetic detection device 32, and a magnetic flux density that was vertical to the first surface 31 was detected. Moreover, the periodic projections and recesses 34 included a starting projection 34A at the end of the magnet 31 in the relative movement direction A1. Each flat section 31G was provided so as to face a projection 34A and a recess 34B of a first period and a projection 34A of a second period, with respect to the corresponding starting projection 34A, and each inclined section 31F was provided so as to face a recess 34B of the second period and a projection 34A of a third period. It is to be noted that FIG. 18 also shows the measurement result of the first embodiment illustrated in FIG. 12.

It is found from FIG. 18 that in the first embodiment, the amplitude and a mid point of the amplitude of the output waveform in the vicinity of the third period from each end starts being varied in comparison with those of the middle region 31C. In contrast, it is found that in this modification example, the amplitudes and midpoints of the amplitudes of the output waveform are substantially constant between the first periods from the respective ends.

Consequently, this modification example enables the total length of the magnet 31 to be decreased by a length corresponding to four periods (2 periods×both ends=4 periods).

Consequently, it is evident that the proper, substantially sinusoidal output is obtainable from not only the middle region 31C but also each outer region 31D even when the length of the middle region 31C is increased, as long as the thickness d2 of the magnet 31 in the middle thereof (the middle region 31C) is set larger than the thickness d1 at each end 31E thereof in the relative movement direction A1 by providing each outer region 31D on the second surface 31B with the inclined section 31F and the flat section 31G.

### Modification Example 2-1 to 2-3

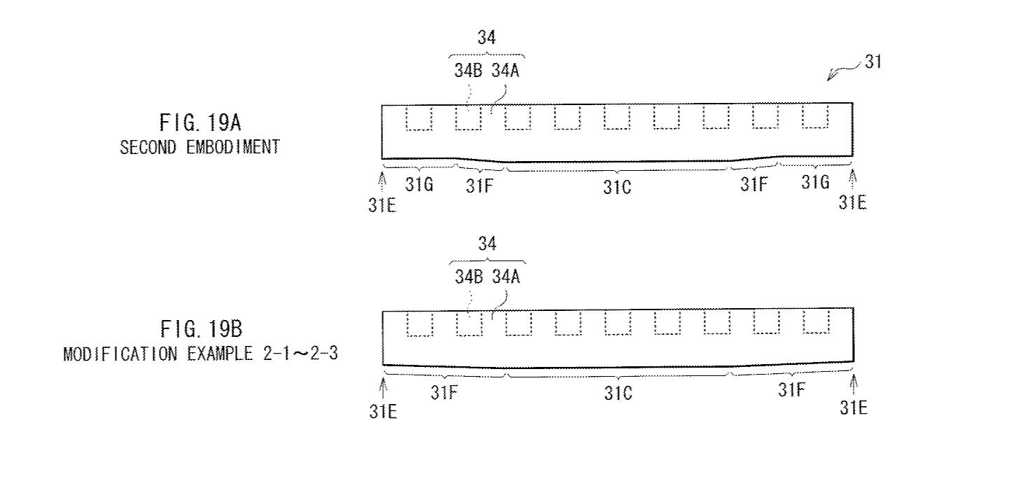

FIG. 19A illustrates the configuration of the magnet 31 of the second embodiment, and FIG. 19B illustrates a configuration of a magnet 31 according to Modification examples 2-1 to 2-3. Except that only the inclined section 31F is provided in each of the outer regions 31D on the second surface 31B and the flat section 31G is removed in the magnet 31 of the second embodiment, each of the modification examples has a similar configuration to that of the second embodiment. In addition, each of the magnets 31 according to Modification examples 2-1 to 2-3 may be manufactured through a similar process to that of the first embodiment. Accordingly, in the following description, the same reference numerals are assigned to components corresponding to those of the first or second embodiment.

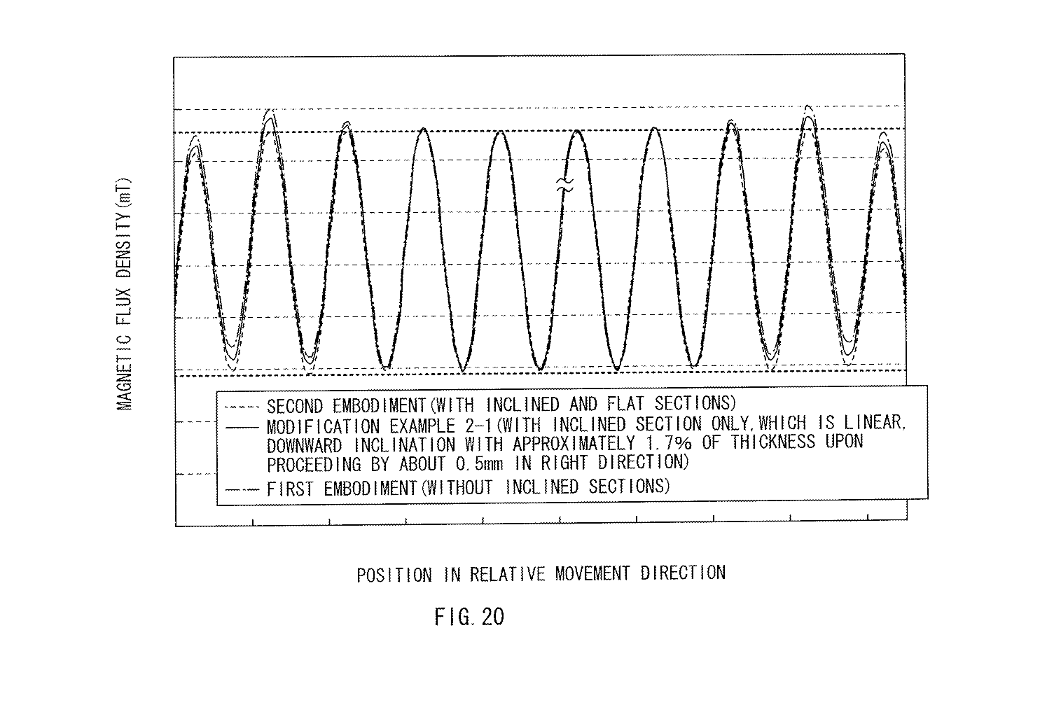

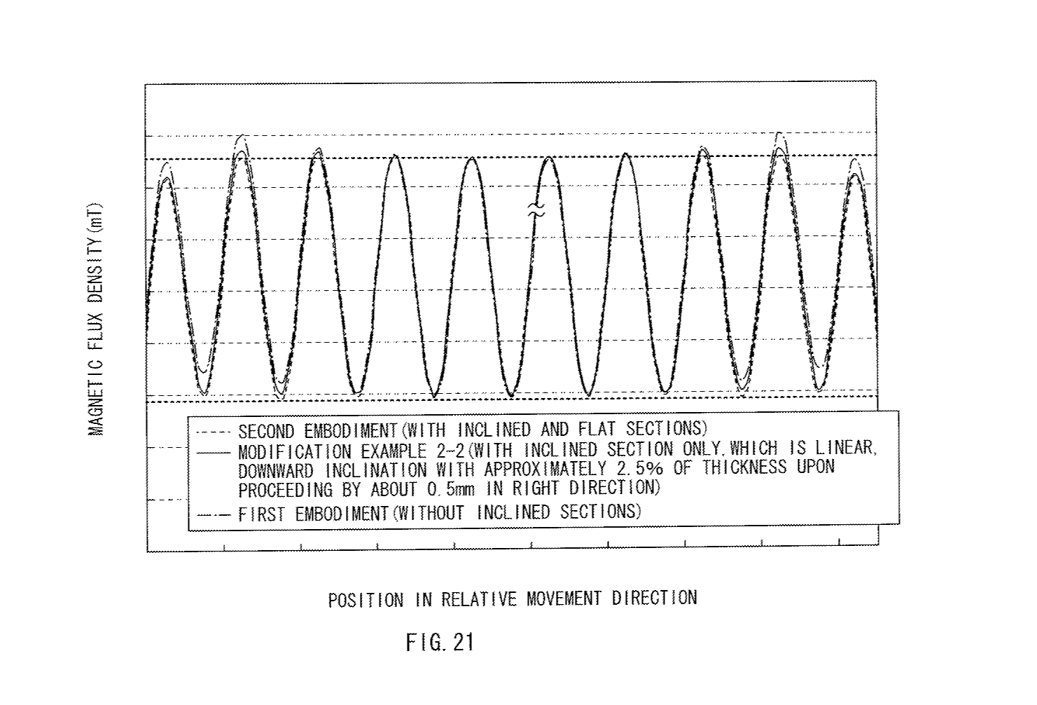

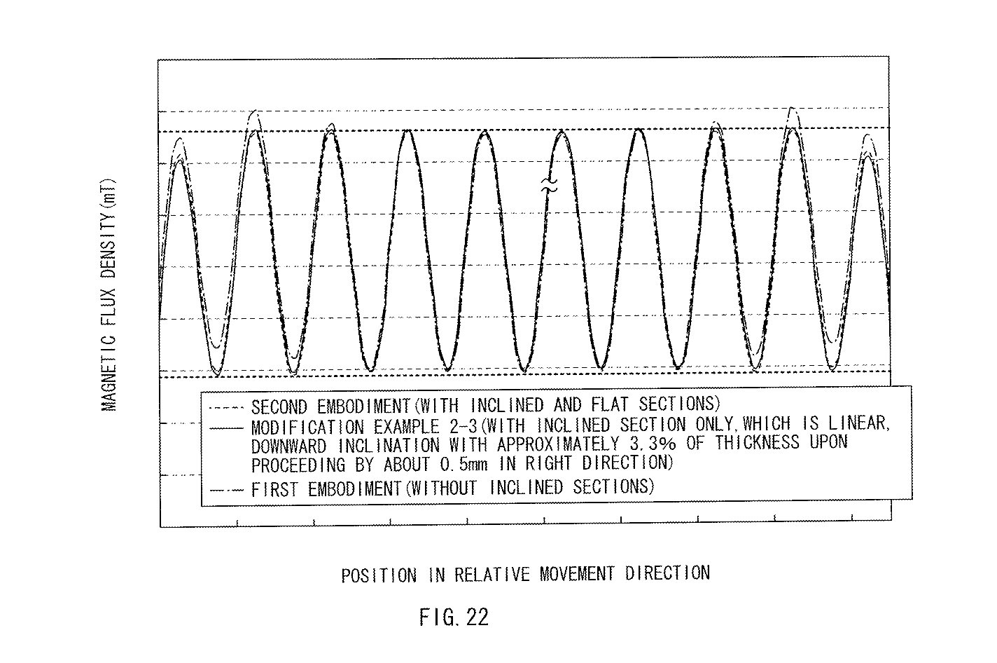

FIGS. 20 to 22 schematically show measurement results of a magnetic field on the first surface 31A of the magnet 31. In this measurement, a Hall device was used as the magnetic detection device 32, and a magnetic flux density that was vertical to the first surface 31 was detected. Moreover, the periodic projections and recesses 34 included a starting projection 34A at the end of the magnet 31 in the relative movement direction A1. Each inclined section 31F was provided so as to face the projections 34A and the recesses 34B of first and second periods and the projection 34A of a third period, with respect to the corresponding starting projection 34A.

In Modification examples 2-1 to 2-3, the respective gradients of the inclined sections 31F were set to differ from one another. In Modification example 2-1, the magnet 31 was configured to have downward inclination that inclines by approximately 1.7% of the thickness of the end 31E of the magnet 31 upon every proceeding by about 0.5 mm in the relative movement direction A1. In Modification example 2-2, the magnet 31 was configured to have a downward inclination that inclines by approximately 2.5% of the thickness of the end 31E of the magnet 31 upon every proceeding by about 0.5 mm in the relative movement direction A1. In Modification example 2-3, the magnet 31 was configured to have a downward inclination that inclines by approximately 3.3% of the thickness of the end 31E of the magnet 31 upon every proceeding by about 0.5 mm in the relative movement direction A1.

It is to be noted that each of FIGS. 20 to 22 also shows the measurement results of the first and second embodiments illustrated in FIGS. 12 and 14.

As seen from FIGS. 20 to 22, all of Modification examples 2-1 to 2-3 suppress the distortion of the output waveform more strongly than the first embodiment without the inclined sections 31F does. It is evident that a proper, substantially sinusoidal output is obtainable from not only the middle region 31C of the magnet 31 but also each outer region 31D thereof, by providing each outer region 31D on the second surface 31B with only the inclined section 31F.

As the gradient of the inclined section 31E increases, the output waveform from each outer region 31D is less distorted. In fact, the output waveform of Modification example 2-3 exhibits substantially the same distortion level as that of the second embodiment. Consequently, it is evident that the more advantageous effect is obtained by adjusting the gradient of each inclined section 31F.

### Modification Example 3

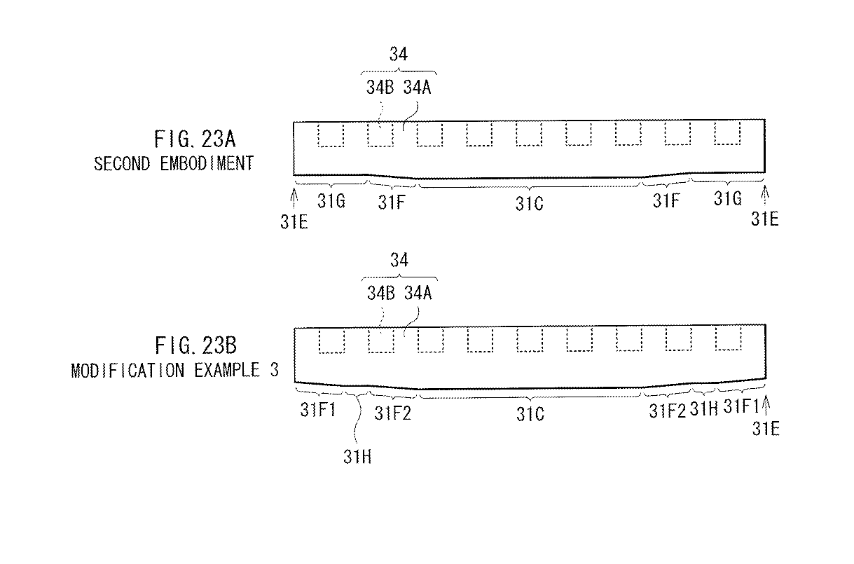

FIG. 23A illustrates the configuration of the magnet 31 of the second embodiment, and FIG. 23B illustrates a configuration of a magnet 31 according to Modification example

3. Except that each outer region 31D on the second surface 31B is provided with two inclined sections 31F1 and 31F2 and a flat intermediate section 31H therebetween in the magnet 31 of the second embodiment, this Modification example 3 has a similar configuration to that of the above-described second embodiment. In addition, the magnet 31 according to Modification example 3 may be manufactured through a similar process to that of the first embodiment. Accordingly, in the following description, the same reference numerals are assigned to components corresponding to those of the first or second embodiment.

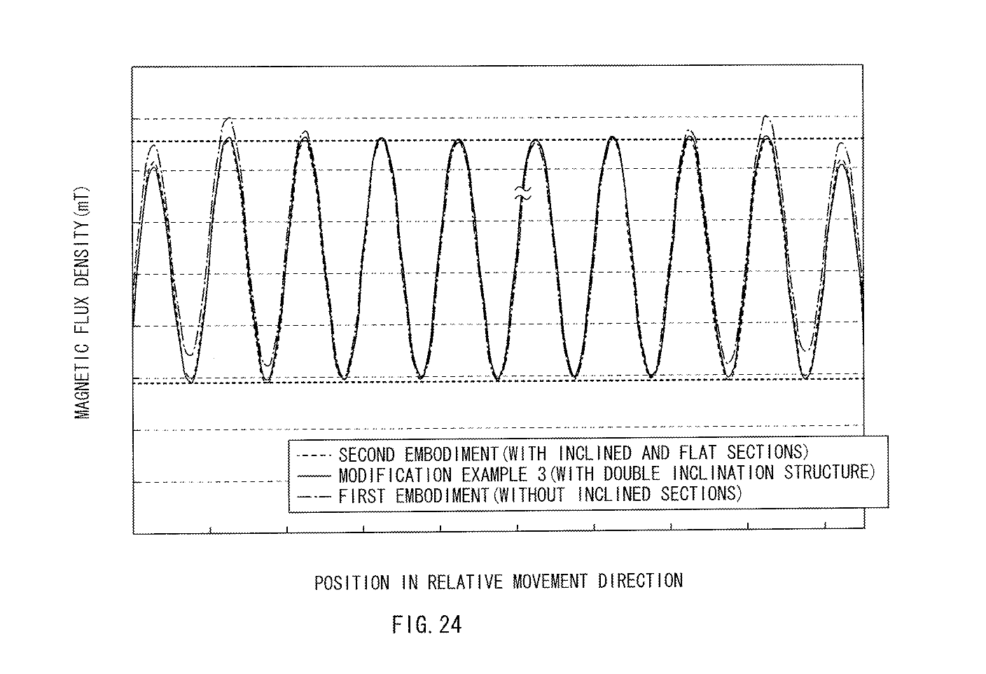

FIG. 24 schematically shows a measurement result of a magnetic field on the first surface 31A of the magnet 31. In this measurement, a Hall device was used as the magnetic detection device 32, and a magnetic flux density that was vertical to the first surface 31 was detected. Moreover, each outermost one of the projections and recesses 34 in the magnet 31 along the relative movement direction A1 was the projection 34A. The first inclined section 31F1 was provided to face a projection 34A and a recess 34B of a first period with respect to the corresponding starting projection 34A; the flat intermediate section 31H was provided to face a projection 34A of a second period; and the second inclined section 31F2 was provided to face a recess 34B of the second period and a projection 34A of a third period. The gradient of each of the first inclined section 31F1 and the second inclined section 31F2 was set such that the magnet 31 had a downward inclination that inclines by approximately 4.2% of the maximum thickness of the magnet 31 upon every proceeding by about 0.5 mm in the relative movement direction A1. It is to be noted that FIG. 24 also shows the measurement results of the first and second embodiments illustrated in FIGS. 12 and 14.

As seen from FIG. 24, Modification example 3 suppresses the distortion of the output waveform more strongly than the first embodiment without the inclined sections 31F does. In fact, the output waveform of Modification example 3 exhibits substantially the same distortion level as that of the second embodiment. Consequently, it is evident that a proper, substantially sinusoidal output is also obtainable from not only the middle region 31C of the magnet 31 but also each outer region 31D thereof, when each outer region 31D on the second surface 31B is provided with the two inclined sections 31F1 and 31F2 and the flat intermediate section 31H therebetween.

Up to this point, the embodiments and the like of the present disclosure have been described. However, the present disclosure is not limited to the embodiments and the like as described above, and various other modifications are possible.

For example, a method of providing the gradient for each inclined section 31F is not limited to that described in the above embodiments and the like. For example, the location of each inclined section 31F, and a difference between the thickness d2 of the middle region 31C and the thickness d1 of end 31E may be changed, depending on the number of periods of periodic projections and recesses 34 on the first surface 31A of the magnet 31 or the length or width of the magnet 31. This method is applicable to the magnet 31 with any given size, and also makes it possible to decrease the total length of the magnet 31 by producing the same advantageous effect as that of the above-described embodiments and the like.

Moreover, there is no limitation regarding, for example, the materials, thicknesses, and manufacturing methods of the components described in the above embodiments and the like. Alternatively, other materials, thicknesses, or manufacturing method thereof may be employed. For example, the periodic projection and recess 34 may be formed with a cutting process.

The above embodiments and the like have been described by concretely exemplifying the configuration of the image pickup apparatus 1. However, it is not necessary for the image pickup apparatus 1 to have all the components, and any other component may be added thereto.

The position detection device according to any of the embodiments and the like of the present disclosure is suitable for sensing long-distance movement (2 mm or longer). Specifically, the position detection device is applicable to a wide variety of fields, including printers, industrial machines, and portable electronic apparatuses equipped with an optical zoom function, such as portable phones and smartphones, in addition to positional detection of a lens of the image pickup apparatus 1.

Note that an embodiment of the present technology may also include the following configuration.

(1) A position detection device including:

a magnet and a magnetic detection device arranged opposite to each other to be relatively movable in a straight-line direction,

wherein the magnet has a first surface facing the magnetic detection device, and has periodic projections and recesses arrayed on the first surface in a relative movement direction.

(2) The position detection device according to (1), wherein

the magnet has the first surface and a second surface, the second surface being opposite to the first surface, and

a distance between the first surface and the second surface at a middle of the magnet along the relative movement direction is longer than a distance between the first surface and the second surface at an end of the magnet along the relative movement direction.

(3) The position detection device according to (2), wherein

an outer region of the magnet includes, on the second surface, an inclined section inclined with respect to the relative movement direction, and

the distance between the first surface and the second surface in the inclined section increases toward the middle of the magnet in the relative movement direction.

(4) The position detection device according to (3), wherein

the periodic projections and recesses include a starting projection at the end of the magnet in the relative movement direction.

(5) The position detection device according to (4), wherein

the outer region of the magnet includes, on the second surface, the inclined section and a flat section in this order of closeness to the middle of the magnet in the relative movement direction.

(6) The position detection device according to any one of (1) to (5), wherein

the magnet includes a rib on a side edge of the first surface.

(7) The position detection device according to (6), wherein

the flat section is provided to face projection and recess of a first period and a projection of a second period, with respect to the starting projection, and

the inclined section is provided to face a recess of the second period and a projection of a third period.

(8) The position detection device according to any one of (1) to (5), wherein

the periodic projections and recesses include, as recesses, grooves provided across the first surface in the direction along the width of the first surface.

(9) The position detection device according to (8), wherein

the flat section is provided to face projections and recesses of a first and a second periods, with respect to the starting projection, and

the inclined section is provided to face a projection of a third period.

(10) The position detection device according to (5), wherein

an outer region of the magnet includes, on the second surface, two inclined sections and a flat intermediate section between the two inclined sections.

(11) The position detection device according to any one of (1) to (10), wherein

the magnet includes projections and recesses alternately, as the periodic projections and recesses.

(12) The position detection device according to any one of (1) to (11), wherein

the magnet is magnetized in a single direction.

(13) An image pickup apparatus including:

a lens configured to be movable in an optical axis direction; and

a position detection device for the lens, the position detection device including a magnet and a magnetic detection device arranged opposite to each other to be relatively movable in a straight-line direction,

wherein the magnet has a first surface facing the magnetic detection device, and has periodic projections and recesses arrayed on the first surface in a relative movement direction.

(14) A magnet to be provided in a position detection device, the position detection device performing positional detection by relatively moving a magnet and a magnetic detection device in a straight-line direction, the magnet and the magnetic detection device arranged opposite to each other, the magnet including:

periodic projections and recesses arrayed on a first surface in a relative movement direction, the first surface facing the magnetic detection device.

It should be understood by those skilled in the art that various modifications, combinations, sub-combinations, and alterations may occur depending on design requirements and other factors insofar as they are within the scope of the appended claims or the equivalents thereof.

What is claimed is:

1. A position detection device comprising:
a magnet and a magnetic detection device arranged opposite to each other to be relatively movable in a straight-line direction,
wherein the magnet has a first surface facing the magnetic detection device, and has periodic projections and recesses arrayed on the first surface in a relative movement direction.

2. The position detection device according to claim 1, wherein
the magnet has the first surface and a second surface, the second surface being opposite to the first surface, and
a distance between the first surface and the second surface at a middle of the magnet along the relative movement direction is longer than a distance between the first surface and the second surface at an end of the magnet along the relative movement direction.

3. The position detection device according to claim 2, wherein
an outer region of the magnet includes, on the second surface, an inclined section inclined with respect to the relative movement direction, and
the distance between the first surface and the second surface in the inclined section increases toward the middle of the magnet in the relative movement direction.

4. The position detection device according to claim 3, wherein
the periodic projections and recesses include a starting projection at the end of the magnet in the relative movement direction.

5. The position detection device according to claim 4, wherein
the outer region of the magnet includes, on the second surface, the inclined section and a flat section in this order of closeness to the middle of the magnet in the relative movement direction.

6. The position detection device according to claim 5, wherein
the magnet includes a rib on a side edge of the first surface.

7. The position detection device according to claim 6, wherein
the flat section is provided to face a projection and a recess of a first period and a projection of a second period, with respect to the starting projection, and
the inclined section is provided to face a recess of the second period and a projection of a third period.

8. The position detection device according to claim 5, wherein
the periodic projections and recesses include, as recesses, grooves provided across the first surface in the direction along the width of the first surface.

9. The position detection device according to claim 8, wherein
the flat section is provided to face projections and recesses of first and second periods, with respect to the starting projection, and
the inclined section is provided to face a projection of a third period.

10. The position detection device according to claim 5, wherein
an outer region of the magnet includes, on the second surface, two inclined sections and a flat intermediate section between the two inclined sections.

11. The position detection device according to claim 1, wherein
the magnet includes projections and recesses alternately, as the periodic projections and recesses.

12. The position detection device according to claim 1, wherein
the magnet is magnetized in a single direction.

13. An image pickup apparatus comprising:
a lens configured to be movable in an optical axis direction; and
a position detection device for the lens, the position detection device including a magnet and a magnetic detection device arranged opposite to each other to be relatively movable in a straight-line direction,
wherein the magnet has a first surface facing the magnetic detection device, and has periodic projections and recesses arrayed on the first surface in a relative movement direction.

14. A magnet to be provided in a position detection device, the position detection device performing positional detection by relatively moving a magnet and a magnetic detection device in a straight-line direction, the magnet and the magnetic detection device arranged opposite to each other, the magnet comprising:
periodic projections and recesses arrayed on a first surface in a relative movement direction, the first surface facing the magnetic detection device.
